(19) United States
(12) Patent Application Publication
(10) Pub. No.: US 2018/0112776 A1
(43) Pub. Date: Apr. 26, 2018

(54) SEALS SEPARATED BY RETAINING CLIP

(71) Applicant: Graco Minnesota Inc., Minneapolis, MN (US)

(72) Inventors: Suresha Saragur Nijaguna, Plymouth, MN (US); John C. Holman, Ham Lake, MN (US); Dustin A. Tichy, Otsego, MN (US)

(21) Appl. No.: 15/568,290

(22) PCT Filed: Apr. 22, 2016
(86) PCT No.: PCT/US2016/028909

§ 371 Date: Oct. 20, 2017

Related U.S. Application Data
(60) Provisional application No. 62/154,227, filed on Apr. 29, 2015.

(51) Int. Cl. F16J 15/16; F16J 15/00; F04B 53/14

(52) U.S. Cl. CPC F16J 15/164; F16N 13/02; F04B 53/143; F16J 15/002

(57) ABSTRACT

A sealing assembly includes retaining clips fit within grooves in a throat disposed between a fluid chamber and a working fluid cylinder. The retaining clips define individual seal glands, and seals and spacers are disposed within the seal glands. A piston rod passes through the throat seal, and the throat seal provides a seal against lubricant pressure from inside the fluid chamber and working fluid pressure from inside the working fluid cylinder.

### CROSS-REFERENCE TO RELATED APPLICATION

This application claims priority to U.S. Provisional Application No. 62/154,227 filed on Apr. 29, 2015, and entitled “SEALS SEPARATED BY RETAINING CLIP,” the disclosure of which is incorporated by reference in its entirety.

### BACKGROUND

Machinery often requires lubrication to function. Seals, pistons, bearings, and other parts require lubrication with small, measured amounts of grease or oil over short, frequent time intervals to prevent wear, corrosion, over-lubrication, or under-lubrication. Lubricant fluid is injected at specific locations that require lubrication by lubricant injectors. Lubricant fluid is drawn from a lubricant reservoir and pumped to the lubricant injectors via a lubrication line. The lubricant injectors are configured to inject a set, small amount of lubricant fluid to the specific location within the machinery once the pressure within the lubrication line reaches a predetermined level. After the lubricant injectors have dispensed the lubricant, the pressure within the lubrication line is relieved, thereby resetting the lubricant system for another lubrication cycle.

### SUMMARY

According to an embodiment of the present disclosure, a sealing assembly includes a first retaining clip, a second retaining clip, and a third retaining clip. The first retaining clip and the second retaining clip define a first seal gland. The third retaining clip and the second retaining clip define a second seal gland. A first seal is disposed within the first seal gland, and a second seal is disposed within the second seal gland.

According to another embodiment of the present disclosure, a lubricant pump includes a pump base defining a fluid chamber, and having a throat, an outlet port, and a fluid chamber extending between the throat and the outlet port. The pump also includes a piston rod extending into the fluid chamber through the throat, and a seal disposed within the throat and extending about the piston rod. The throat includes a first groove, a second groove, and a third groove. The seal includes a first retaining clip disposed within the first groove, a second retaining clip disposed within the second groove, and a third retaining clip disposed within the third groove. The first retaining clip and the second retaining clip define a first seal gland. The third retaining clip and the second retaining clip define a second seal gland. A first seal is disposed within the first seal gland. A second seal is disposed within the second seal gland.

According to yet another embodiment, a lubrication system includes a pump, a lubricant supply line connected to the pump and configured to provide lubricant downstream to lubricant applicators, and a working fluid supply connected to the pump through a first working fluid supply line and a second working fluid supply line. The pump includes a pump base defining a fluid chamber, and having a throat, a fill port, and an outlet port, an working fluid cylinder attached to the pump base, a lubricant reservoir attached to the pump base and configured to provide lubricant to the fluid chamber through the fill port, a piston disposed within the working fluid cylinder, a piston rod extending from the piston and into the fluid chamber through the throat, and a seal disposed within the throat and extending about the piston rod. The throat includes a first groove, a second groove, and a third groove. The seal includes a first retaining clip disposed within the first groove, a second retaining clip disposed within the second groove, and a third retaining clip disposed within the third groove. The first retaining clip and the second retaining clip define a first seal gland. The third retaining clip and the second retaining clip define a second seal gland. A first seal is disposed within the first seal gland. A second seal is disposed within the second seal gland.

### BRIEF DESCRIPTION OF THE DRAWINGS

FIG. 1 is a schematic diagram of a lubrication system.

FIG. 2 is a cross-sectional view of a lubricant pump.

FIG. 2A is an enlarged view of detail Z of FIG. 2.

FIG. 3 is an exploded view of a throat seal.

### DETAILED DESCRIPTION

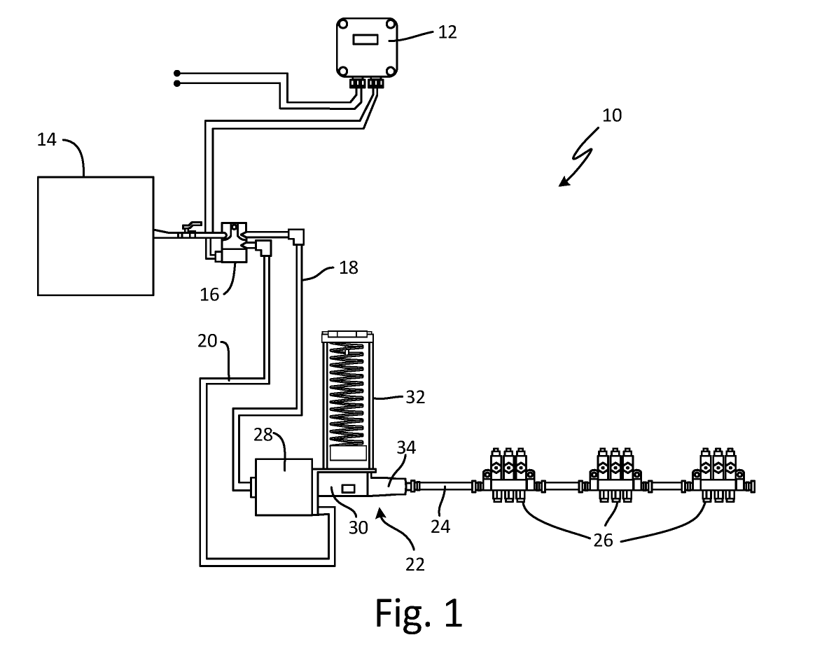

FIG. 1 is a schematic diagram of lubrication system 10, a system that receives, stores, and supplies lubricant fluid. Lubrication system 10 includes control 12, working fluid supply 14, valve 16, first working fluid line 18, second working fluid line 20, lubricant pump 22, lubrication line 24, and lubricant injectors 26. Lubricant pump 22 includes working fluid cylinder 28, base 30, reservoir 32, and outlet valve 34. Working fluid supply 14 is connected to valve 16. Valve 16 is connected to working fluid cylinder 28 through first working fluid line 18 and second working fluid line 20. Working fluid cylinder 28 is secured to base 30. Reservoir 32 is also secured to base 30. Outlet valve 34 is secured to base 30 and to lubrication line 24. Lubricant pump 22 is connected to lubricant injectors 26 by lubrication line 24 extending from outlet valve 34.

Lubricant system 10 is a dedicated lubrication system for use with lubricated machinery such as pumps, pistons, seals, bearings, and/or shafts. Reservoir 32 stores lubricant fluid for distribution to downstream lubricant injectors 26. Lubricant pump 22 builds a pressure in lubrication line 24 until the pressure reaches a pre-determined level. When the pressure in lubrication line 24 reaches the pre-determined level the pressure causes the lubricant injectors 26 to dispense lubricant, thereby providing a set amount of lubricant to the machinery.

To build pressure in lubricant line 24, lubricant pump 22 is primed with lubricant from reservoir 32. The lubricant, which is typically a grease or oil, is stored within base 30 until such time that the lubricant is to be applied to the machinery. To drive the lubricant downstream from lubricant pump 22, working fluid supply 14 provides a first portion of a working fluid, such as compressed air or hydraulic oil, to working fluid cylinder 28 through valve 16 and first working fluid line 18. Control 12 commands valve 16 to actuate to a first position, whereby the working fluid is directed through first working fluid line 18. The first portion of working fluid actuates a piston housed within working fluid cylinder 28 and pushes the piston into a forward stroke, wherein the piston drives a piston rod through base 30. The piston rod drives the lubricant from base 30, through outlet valve 34, and into lubrication line 24 thereby causing a pressure within lubrication line 24 to build. The pressure continues to build within lubrication line 24 as piston continues the forward stroke until the pressure reaches a level sufficient to cause lubricant injectors 26 to dispense lubricant.

After lubricant injectors 26 have dispensed the lubricant, the pressure in lubrication line 24 is relieved thereby allowing lubricant injectors 26 to reset. Control 12 commands valve 16 to shift to a second position, wherein valve 16 directs a second portion working fluid from working fluid supply 14 to an opposite side of the piston through second working fluid line 20, thereby pushing the piston into a return stroke. While the second portion of working fluid is driving the piston into the return stroke, the first portion of working fluid is exhausted from working fluid cylinder 28 through first working fluid line 18 and valve 16. During the return stroke, the piston pulls the piston rod back through base 30, thereby reducing the pressure in fluid chamber 54 and drawing a portion of the lubricant remaining in lubrication line 24 back into base 30 through outlet valve 34. The lubricant flowing into base 30 through outlet valve 34 allows the pressure in lubrication line 24 to drop, thereby allowing lubricant injectors 26 to reset for another lubrication cycle. When the piston completes the return stroke, additional lubricant in loaded into base 30 from reservoir 32, thereby priming lubricant pump 22 for another lubrication cycle.

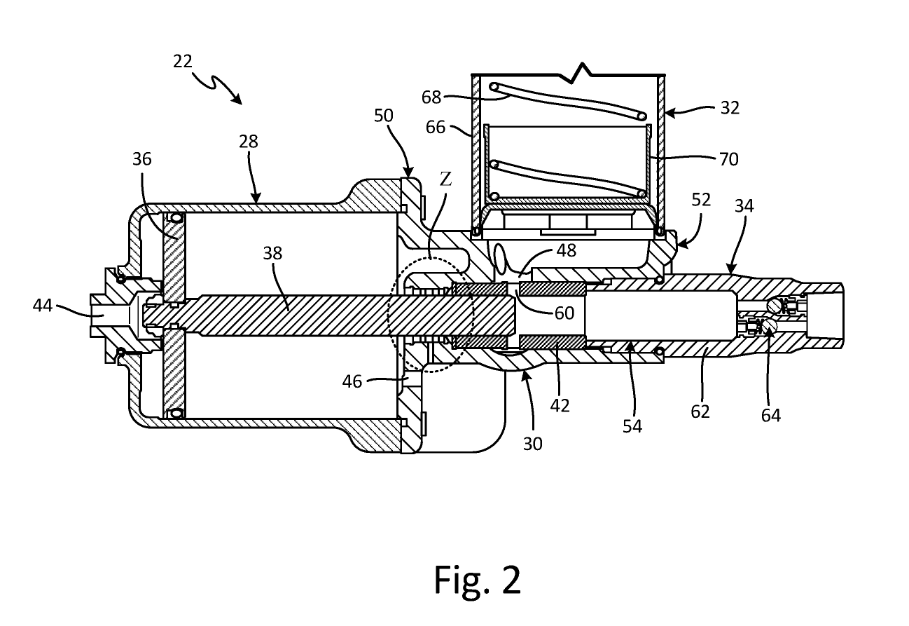

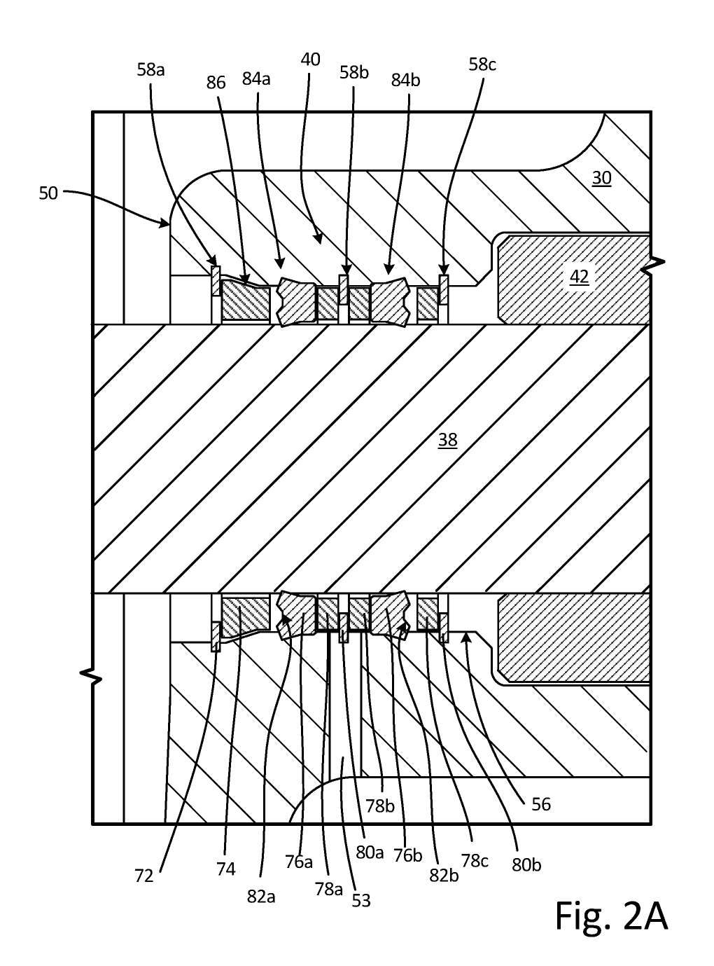

FIG. 2 is a cross-sectional view of lubricant pump 22. FIG. 2A is an enlarged view of detail Z of FIG. 2. FIGS. 2 and 2A will be discussed together. Lubricant pump 22 includes working fluid cylinder 28, base 30, reservoir 32, outlet valve 34, piston 36, piston rod 38, sealing assembly 40, and pump sleeve 42. Working fluid cylinder 28 includes first inlet 44. Base 30 includes second inlet 46, fill port 48, first end 50, second end 52, weep hole 53, and fluid chamber 54 extending between first end 50 and second end 52. First end 50 includes throat 56, and throat 56 includes first groove 58a, second groove 58b, and third groove 58c. Pump sleeve 42 includes opening 60. Outlet valve 34 includes valve body 62 and two-way valve 64 disposed within valve body 62. Reservoir 32 includes reservoir housing 66, spring 68, and follower plate 70. Sealing assembly 40 includes first retaining ring 72, first spacer 74, first seal 76a, second spacer 78a, second retaining ring 80a, third spacer 78b, second seal 76b, fourth spacer 78c, and third retaining ring 80b. First seal 76a includes lip 82a, and second seal 76b includes lip 82b. First retaining ring 72 and second retaining ring 80a define first seal gland 84a, and second retaining ring 80a and third retaining ring 80b define second seal gland 84b. First spacer 74 includes tapered outer wall 86.

Working fluid cylinder 28 is secured to base 30. Piston 36 is disposed within working fluid cylinder 28, and piston rod 38 is secured to piston 36. Piston rod 38 extends from piston 36 and into base 30 through throat 56 and sealing assembly 40. Piston rod 38 extends into pump sleeve 42. Pump sleeve 42 is disposed within fluid chamber 54 such that opening 60 is aligned with fill port 48 to allow lubricant to flow into fluid chamber 54 from reservoir 32. Outlet valve 34 is secured to second end 52 of base 30 and extends into base 30. Outlet valve 34 is adjacent pump sleeve 42 to retain pump sleeve 42 at a desired location within base 30. Reservoir 32 is secured to base 30 and provides a supply of lubricant to fluid chamber 54 through fill port 48 and openings 60. Spring 68 and follower plate 70 are disposed within reservoir housing 66. Follower plate 70 is disposed on top of the lubricant stored within reservoir housing 66. Spring 68 exerts a downward force on follower plate 70. First inlet 44 extends into working fluid cylinder 28 to allow a working fluid to enter working fluid cylinder 28 on a first side of piston 36 to actuate piston 36 into a forward stroke. Second inlet 46 extends through base 30 and provides a fluid connection to working fluid cylinder 28 to allow the working fluid to enter working fluid cylinder 28 on an opposite side of piston 36 to actuate piston 36 into a return stroke.

Sealing assembly 40 is disposed within throat 56 and surrounds piston rod 38 as piston rod 38 extends through throat 56. Weep hole 53 extends through base 40 and into throat 56. First retaining ring 72 is disposed within first groove 58a, second retaining ring 80a is disposed within second groove 58b, and third retaining ring 80b is disposed within third groove 58c. In this way, first retaining ring 72 and second retaining ring 80a form first seal gland 84a, and third retaining ring 80b and second retaining ring 80a form second seal gland 84b. First spacer 74 is disposed within first seal gland 84a adjacent first retaining ring 72, and second spacer 78a is disposed within first seal gland 84a adjacent second retaining ring. First seal 76a is disposed within first seal gland 84a between first spacer 74 and second spacer 78a. Third spacer 78b is disposed within second seal gland 84b adjacent second retaining ring 80a, and fourth spacer 78c is disposed within second seal gland 84b adjacent third retaining ring 80b. Second seal 76b is disposed within second seal gland 84b between third spacer 78b and fourth spacer 78c.

During operation, lubricant pump 22 drives a lubricant downstream from fluid chamber 54, through two-way valve 64, and to lubricant injectors 26 (shown in FIG. 1). To drive the lubricant downstream, working fluid enters working fluid cylinder 28 through first inlet 44. The working fluid drives piston 36 into a forward stroke, and piston 36 correspondingly drives piston rod 38 into fluid chamber 54. Piston rod 38 extending into fluid chamber 54 increases the pressure within fluid chamber 54, and the pressure in fluid chamber 54 continues to build until two-way valve 64 opens. When two-way valve 64 opens, the lubricant may flow downstream from fluid chamber 54, through two-way valve 64 and lubrication line 24 (shown in FIG. 1), and to lubricant injectors 26. The pressure within lubrication line 24 continues to build until the pressure reaches a predetermined level causing the lubricant injectors 26 to dispense lubricant.

After completing the forward stroke, piston 36 is driven into the reverse stroke. Working fluid enters working fluid cylinder 28 on an opposite side of piston 36 through second inlet 46, to drive piston 36 in the reverse stroke. Piston 36 continues along the reverse stroke until a distal end of piston rod 38 passes openings 60, thereby allowing lubricant from reservoir 32 to enter fluid chamber 54. With the lubricant loaded in fluid chamber 54, lubricant pump 22 is again primed and ready for another lubrication cycle.

Sealing assembly 40 forms a seal between fluid chamber 54 and working fluid cylinder 28. Sealing assembly 40 experiences fluid pressure from both the lubricant within fluid chamber 54 and the working fluid within working fluid cylinder 28. First seal 76a is disposed within first seal gland 84a such that lip 82a faces towards working fluid cylinder 28. In this way, first seal 76a handles fluid pressure from the working fluid within working fluid cylinder 28. Similarly, second seal 76b is disposed within second seal gland 84b such that lip 82b faces towards fluid chamber 54. Second seal 76b thus handles the fluid pressure from the lubricant disposed within fluid chamber 54. Weep hole 53 extends through base 30 and into throat 56 between first seal 76a and second seal 76b. Weep hole 53 prevents excess pressure from building up between first seal 76a and second seal 76b by allowing air to vent in and out of throat 56 from the area disposed between first seal 76a and second seal 76b.

As shown in FIG. 2A, a diameter of throat 56 may be larger proximate working fluid cylinder 28 than proximate fluid chamber 54. As such, first spacer 74 includes tapered outer wall 86 to conform to the contour of a wall of throat 56 as the diameter of throat 56 transitions between the larger diameter and the smaller diameter. In addition, first retaining ring 72 may have a larger diameter than a diameter of second retaining ring 80a or a diameter of third retaining ring 80b, as first retaining ring 72 is disposed within throat 56 proximate working fluid cylinder 28, where a diameter of throat is larger. It is understood, however, that throat 56 may include a single diameter or a larger diameter proximate fluid chamber 54. As such, first retaining ring 72 may be the same diameter as either second retaining ring 80a or third retaining ring 80b, and first spacer 74 may include a smooth outer wall.

First spacer 74 and second spacer 78a are adjacent to and disposed on either side of first seal 76a, and first spacer 74 and second spacer 78a provide firm support to first seal 76a. Similarly, third spacer 78b and fourth spacer 78c are adjacent to and disposed on either side of second seal 76b, such that third spacer 78b and fourth spacer 78c provide firm support to second seal 76b. First seal 76a faces opposite of second seal 76b to handle the fluid pressure from working fluid cylinder 28 and fluid chamber 54, respectively.

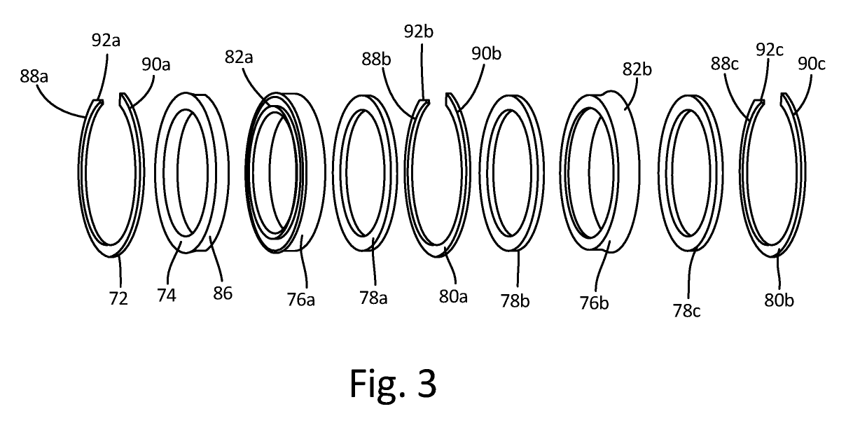

FIG. 3 is an exploded view of sealing assembly 40. Sealing assembly 40 includes first retaining ring 72, first spacer 74, first seal 76a, second spacer 78a, second retaining ring 80a, third spacer 78b, second seal 76b, fourth spacer 78c, and third retaining ring 80b. First retaining ring 72 includes first end 88a and second end 90a. Second retaining ring 80a includes first end 88b and second end 90b. Third retaining ring 80b includes first end 88c and second end 90c. First spacer 74 includes tapered outer wall 86. First seal 76a includes lip 82a, and second seal 76b includes lip 82b (best seen in FIG. 2A). First end 88a includes tapered edge 92a, first end 88b includes tapered edge 92b, and first end 88c includes tapered edge 92c.

First spacer 74 is disposed adjacent first retaining ring 72, and second spacer is disposed adjacent second retaining ring 80a. First retaining ring 72 and second retaining ring 80a define first seal gland 84a, within which first seal 76a is preferably disposed. Third spacer 78b is disposed adjacent second retaining ring 80a on an opposite side of second retaining ring 80a from second spacer 78a. Third spacer 78b is disposed adjacent third retaining ring 80b. Second retaining ring 80a and third retaining ring 80b define second seal gland 84b, within which second seal 76b is preferably disposed. First seal 76a is disposed within first seal gland 84a such that lip 82a of first seal 76a are adjacent first spacer 74. Second seal 76b is disposed within second seal gland 84b such that lip 82b of second seal 76b is adjacent fourth spacer 78c. In this way, first seal 76a may be a unidirectional seal configured to seal against fluid pressure acting on lip 82a. Similarly, second seal 76b may be a unidirectional seal configured to seal against fluid pressure acting on lip 82b, which are oppositely oriented from lip 82a. As such, first seal 76a and second seal 76b are configured to seal against fluid pressure from two, opposite directions.

First end 88a of first retaining ring 72 may include tapered edge 92a. Tapered edge 92a of first end 88a allows for easy removal of first retaining ring 72 from a groove, such as first groove 58a (best seen in FIG. 2A), when first retaining ring 72 is seated within the groove. For example, a blade of a flat head screwdriver, or some other tool, may fit under tapered edge 92a to easily remove first retaining ring 72. Similarly, first end 88b of second retaining ring 80a may include tapered edge 92b, and first end 88c of third retaining ring 80b may include tapered edge 92c. While each of first retaining ring 72, second retaining ring 80a, and third retaining ring 80b are described as including a first end and a second end, it is understood that each of first retaining ring 72, second retaining ring 80a, and third retaining ring 80b may be a full ring.

As shown, first seal 76a is a unidirectional seal configured to seal against fluid pressure acting on first seal gland 84a from the side of first retaining ring 72. Second seal 76b is similarly a unidirectional seal configured to seal against fluid pressure acting on second seal gland 84b from the side of third retaining ring 80b. While both first seal 76a and second seal 76b are described as unidirectional seals, it is understood that first seal 76a, second seal 76b, or both may be bidirectional seals. Moreover, it is understood that sealing assembly 40 may include a single bidirectional seal disposed between two retaining rings.

Sealing assembly 40 provides significant advantages. First seal gland 84a being formed by first retaining ring 72 and second retaining ring 80a, and second seal gland 84b being formed by second retaining ring 80a and third retaining ring 80b provides significant advantages. The retaining clips forming seal glands provides desired concentricity for the seals, and the individual seal glands prevent the first seal and the second seal from being squeezed into one another, which could lead to leakage around the seals. In addition, seal glands created by retaining clips are easier to maintain than machined seal glands. In addition, the grooves to position the retaining clips are easier to machine and allow for more precise machining than that of individual seal glands.

Although the present invention has been described with reference to preferred embodiments, workers skilled in the art will recognize that changes may be made in form and detail without departing from the spirit and scope of the invention.

1. A sealing assembly comprising:
a first retaining clip;
a second retaining clip spaced from the first retaining clip, wherein the first retaining clip and the second retaining clip define a first seal gland;
a third retaining clip spaced from the second retaining clip, wherein the third retaining clip and the second retaining clip define a second seal gland;
a first seal disposed within the first seal gland; and
a second seal disposed within the second seal gland.

2. The sealing assembly of claim 1, and wherein the first retaining clip is disposed within a first groove, the second retaining clip is disposed within a second groove, and the third retaining clip disposed within a third groove.

3. The sealing assembly of claim 1, and further comprising:
a first spacer disposed within the first seal gland between the first retaining clip and the first seal;
a second spacer disposed within the first seal gland between the second retaining clip and the first seal;
a third spacer disposed within the second seal gland between the second retaining clip and the second seal; and
a fourth spacer disposed within the second seal gland between the third retaining clip and the second seal.

4. The sealing assembly of claim 3, wherein the first spacer includes a tapered outer wall.

5. The sealing assembly of claim 1, wherein a diameter of the first retaining ring is greater than a diameter of the second retaining ring and the third retaining ring.

6. The sealing assembly of claim 1, wherein the first seal is a unidirectional seal configured to face the first retaining ring, and wherein the second seal is a unidirectional seal configured to face the third retaining ring.

7. The sealing assembly of claim 6, wherein the first seal includes a first lip disposed adjacent the first retaining ring, and wherein the second seal includes a second lip disposed adjacent the third retaining ring.

8. A lubricant pump comprising:
a pump base having a throat, an outlet port, and a fluid chamber extending between the throat and the outlet port, wherein the throat includes a first groove, a second groove, and a third groove;
a piston rod extending into the fluid chamber through the throat; and
a seal disposed within the throat and extending about the piston rod,
wherein the seal comprises:
a first retaining clip disposed within the first groove;
a second retaining clip disposed within the second groove, wherein the first retaining clip and the second retaining clip define a first seal gland; and
a third retaining clip disposed within the third groove, wherein the third retaining clip and the second retaining clip define a second seal gland;
a first seal disposed within the first seal gland; and
a second seal disposed within the second seal gland.

9. The lubricant pump of claim 8, and further comprising:
a first spacer disposed within the first seal gland between the first retaining clip and the first seal;
a second spacer disposed within the first seal gland between the second retaining clip and the first seal;
a third spacer disposed within the second seal gland between the second retaining clip and the second seal; and
a fourth spacer disposed within the second seal gland between the third retaining clip and the second seal.

10. The lubricant pump of claim 9, wherein the first spacer includes a tapered outer wall.

11. The lubricant pump of claim 8, wherein a diameter of the first retaining ring is greater than a diameter of the second retaining ring and the third retaining ring.

12. The lubricant pump of claim 8, and further comprising:
a weep hole extending through the pump base and into the throat, wherein the weep hole extends into the throat between the first seal and the second seal.

13. The lubricant pump of claim 8, wherein the first seal is a unidirectional seal configured to face the first retaining ring, and wherein the second seal is a unidirectional seal configured to face the third retaining ring.

14. The lubricant pump of claim 13, wherein:
the first seal includes a first lip facing the first retaining ring; and
the second seal includes a second lip facing the third retaining ring.

15. A lubrication system comprising:
a pump comprising:
a pump base defining a fluid chamber, and having a throat, a fill port, and an outlet port, wherein the throat includes a first groove, a second groove, and a third groove;
a working fluid cylinder attached to the pump base;
a lubricant reservoir attached to the pump base, and configured to provide lubricant to the fluid chamber through the fill port;
a piston disposed within the working fluid cylinder;
a piston rod extending from the piston and into the fluid chamber through the throat; and
a seal disposed within the throat and extending about the piston rod, wherein the seal comprises:
a first retaining clip disposed within the first groove;
a second retaining clip disposed within the second groove, wherein the first retaining clip and the second retaining clip define a first seal gland; and
a third retaining clip disposed within the third groove, wherein the third retaining clip and the second retaining clip define a second seal gland;
a first seal disposed within the first seal gland; and
a second seal disposed within the second seal gland;
a lubrication line connected to the outlet port, and configured to provide lubricant downstream to lubricant applicators; and
a working fluid supply connected to the working fluid cylinder through a first working fluid supply line and a second working fluid supply line.

16. The lubrication system of claim 15, and further comprising:
a first spacer disposed within the first seal gland between the first retaining clip and the first seal;
a second spacer disposed within the first seal gland between the second retaining clip and the first seal;
a third spacer disposed within the second seal gland between the second retaining clip and the second seal; and
a fourth spacer disposed within the second seal gland between the third retaining clip and the second seal.

17. The lubrication system of claim 16, wherein the first spacer includes a tapered outer wall.

18. The lubrication system of claim 15, wherein a diameter of the first retaining ring is greater than a diameter of the second retaining ring and the third retaining ring.

19. The lubrication system of claim 15, and further comprising:
a weep hole extending through the pump base and into the throat, wherein the weep hole extends into the throat between the first seal and the second seal.

20. The lubrication system of claim 15, wherein the first seal is a unidirectional seal configured to seal working fluid pressure from the working fluid cylinder, and wherein the second seal is a unidirectional seal configured seal lubricant pressure from the fluid chamber.
